(19) United States
(12) Patent Application Publication
(10) Pub. No.: US 2017/0072972 A1
(43) Pub. Date: Mar. 16, 2017

(54) SYSTEM FOR MONITORING OPERATION OF A LOCOMOTIVE

(71) Applicant: Electro-Motive Diesel, Inc., LaGrange, IL (US)

(72) Inventors: Alexander Shubs, Chicago, IL (US); James David Seaton, Westmont, IL (US); David Matthew Roenspies, Elburn, IL (US)

(73) Assignee: Electro-Motive Diesel, Inc., LaGrange, IL (US)

(21) Appl. No.: 14/855,566

(22) Filed: Sep. 16, 2015

(51) Int. Cl. B61L 23/00; H04N 5/77; B61L 15/00; G06F 3/048; B61L 25/00; H04N 5/225; H04N 5/91

(52) U.S. Cl. CPC B61L 23/00; H04N 5/2253; H04N 5/772; H04N 5/91; G06F 3/048; B61L 25/00; B61L 15/009

(57) ABSTRACT

A system for monitoring operation of a locomotive includes a plurality of cameras, a controller, and at least one graphical user interface (GUI). The cameras are strategically mounted to the locomotive such that each camera is configured to capture a video stream of an environment associated with the locomotive. The controller is remotely disposed from and communicably coupled to each of the cameras over a wireless network. The controller is configured to receive a plurality of video streams from the plurality of cameras. The graphical user interface (GUI) is communicably coupled to the controller. The GUI is configured to display the plurality of video streams received at the controller. In embodiments disclosed herein, the controller is operable for modulating various operating parameters of the locomotive based on the environment associated with the locomotive, as determined from one or more video streams transmitted by the cameras.

### TECHNICAL FIELD

The present disclosure relates to a locomotive, and more particularly, to a system for monitoring operation of a locomotive.

### BACKGROUND

Locomotives typically employ control systems for monitoring their performance and operation over a railroad. Some of these control systems may present an operator with statistical data, graphical data, and/or virtual representations of performance related to various systems of the locomotive. However, operators of locomotives may sometimes be remotely located and it may be helpful if the operator can be provided with a video that helps visually relate to the performance of the locomotive.

U.S. Publication 2015/0021444 relates to a system for providing remote vision to a remote operator with respect to one or more machines. The system includes a remote vision system and a wireless transmitter/receiver for communicating with each of the one or more machines. One or more video feeds are available from each machine upon demand. A controller console linked to the remote vision system receives machine data from each of the one or more machines and selects one or more video feeds for display based on the received machine data. The controller console also specifies a resolution for each selected video feed based on the received machine data, such that the transmission of the selected video feeds does not exceed the available bandwidth. The controller console may modify the video selection or resolution specification during operation of the one or more machines based on additional received machine data.

Although, the '444 publication discloses a system for providing remote vision to a remote operator with respect to one or more machines, these machines are typically used in a mine site or a job site. Conditions associated with a locomotive and/or prevalent within an environment of the locomotive may differ from that generally associated with machines in mine sites and/or job sites.

Hence, there is a need for a system that monitors operation of a locomotive in a given environment.

### SUMMARY OF THE DISCLOSURE

In one aspect of the present disclosure, a system for monitoring operation of a locomotive includes a plurality of cameras, a controller, and at least one graphical user interface (GUI). The cameras are strategically mounted to the locomotive such that each camera is configured to capture a video stream of an environment associated with the locomotive. The controller is remotely disposed from and communicably coupled to each of the cameras over a wireless network. The controller is configured to receive a plurality of video streams from the plurality of cameras. The graphical user interface (GUI) is communicably coupled to the controller. The GUI is configured to display the plurality of video streams received at the controller. In embodiments disclosed herein, the controller is operable for modulating various operating parameters of the locomotive based on the environment associated with the locomotive, as determined from one or more video streams transmitted by the cameras.

In another aspect of the present disclosure, a computer-implemented method for monitoring operation of a locomotive includes mounting a plurality of cameras onto the locomotive; capturing, by at least one camera, a video stream of an environment associated with the locomotive; and transmitting wirelessly, by a transceiver, the video streams from the plurality of cameras to a controller. The method further includes modulating, at the controller, one or more operational parameters of the locomotive based on the environment associated with the locomotive, as determined from one or more video streams transmitted by the plurality of cameras to the controller.

Other features and aspects of this disclosure will be apparent from the following description and the accompanying drawings.

### BRIEF DESCRIPTION OF THE DRAWINGS

FIG. 1 is a schematic representation of a locomotive system, in which embodiments of the present disclosure can be implemented;

FIG. 2 is a diagrammatic view of an exemplary customizable portable computing device for displaying videos pertaining to the locomotive, in accordance with various embodiments of the disclosure;

FIG. 3 is a schematic representation of a remote operator center facilitating communication between the locomotive and a system for monitoring operation of the locomotive;

FIG. 4 is a computer-implemented method showing steps for monitoring operation of the locomotive, according to an embodiment of the present disclosure; and

FIG. 5 is a block diagram of an exemplary computer system, according to an embodiment of the present disclosure.

### DETAILED DESCRIPTION

The detailed description of exemplary embodiments of the disclosure herein makes reference to the accompanying drawings and figures, which show the exemplary embodiments by way of illustration only. While these exemplary embodiments are described in sufficient detail to enable those skilled in the art to practice the disclosure, it should be understood that other embodiments may be realized and that logical and mechanical changes may be made without departing from the spirit and scope of the disclosure. It will be apparent to a person skilled in the pertinent art that this disclosure can also be employed in a variety of other applications. Thus, the detailed description herein is presented for purposes of illustration only and not of limitation. For example, the steps recited in any of the method or process descriptions may be executed in any order and are not limited to the order presented. As such, other alternatives can also be provided to the method or process descriptions where one or more steps are added, one or more steps are removed, or one or more steps are provided in a different sequence without departing from the scope of the claims herein.

For the sake of brevity, conventional data networking, application development and other functional aspects of the systems (and components of the operating systems) may not be described in detail herein. Furthermore, the connecting lines shown in the various figures contained herein are intended to represent exemplary functional relationships and/or physical/communicative couplings between the various elements. It should be noted that many alternative or additional functional relationships or physical/communicative connections may be present in a practical system.

The present disclosure is described herein with reference to system architecture, block diagrams and flowchart illustrations of methods, and computer program products according to various aspects of the disclosure. It will be understood that each functional block of the block diagrams, the flowchart illustrations, and combinations of functional blocks in the block diagrams, the flowchart illustrations, and combinations of functional blocks in the block diagrams, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce output/s that implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. It should be further appreciated that the multiple steps as illustrated and described as being combined into a single step for the sake of simplicity may be expanded into multiple steps. In other cases, steps illustrated and described as single process steps may be separated into multiple steps but have been combined for simplicity.

It may be further noted that references in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to affect such feature, structure, or characteristic in connection with other embodiments whether or not explicitly described.

The systems, methods and computer program products disclosed in conjunction with various embodiments of the present disclosure are embodied in systems, modules, and methods for controlling operation of a machine. Specific nomenclature used herein is merely exemplary and only used for descriptive purposes. Hence, such nomenclature must not be construed as being limiting of the scope of the present disclosure.

The present disclosure will now be described in more detail herein in terms of the above-disclosed exemplary embodiments of system, methods, processes and computer program products. This is for convenience only and is not intended to limit the application of the present disclosure. In fact, after reading the following description, it will be apparent to one skilled in the relevant art(s) how to implement the following disclosure in alternative embodiments.

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims

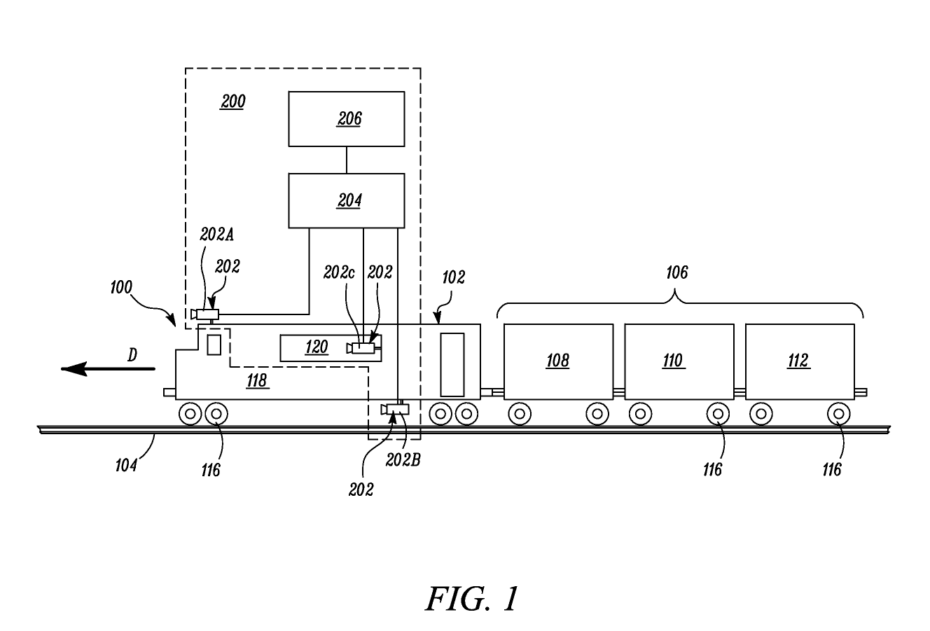

FIG. 1 shows a schematic representation of a locomotive system 100, in which embodiments of the present disclosure can be implemented. As shown in FIG. 1, the locomotive system 100 includes a locomotive 102 configured to run on rails 104. The locomotive 102 may be of any type. In one embodiment, the locomotive 102 may be a steam locomotive. In another embodiment, the locomotive 102 may be a diesel locomotive including a gas engine therein. In another embodiment, the locomotive 102 may be an electric locomotive employing one or more pantographs to draw power from an overhead catenary.

The locomotive system 100 can further include a consist 106 of revenue cars 108, 110, and 112 coupled one behind the other. The consist 106 can be powered by the locomotive 102 such that wheels 116 of the revenue cars 108, 110, and 112 roll on the rails 104. Although four revenue cars 108, 110, and 112 are shown in various embodiments herein, it is to be understood that the number of revenue cars shown is merely exemplarily in nature, and hence, non-limiting of this disclosure. Thus, the consist 106 may include any number of revenue cars therein without deviating from the scope or spirit of the present disclosure.

In an embodiment as shown in FIG. 1, the locomotive 102 is a puller locomotive i.e., the locomotive 102 is disposed before the consist 106 and configured to pull the consist 106 in a direction of travel ‘D’. However, in another embodiment, the locomotive system 100 may additionally include a pusher locomotive disposed after the consist 106. The pusher locomotive would also be configured to push the consist 106 in the direction of travel ‘D’. Therefore, in the preceding embodiment, the puller locomotive and the pusher locomotive can co-operatively drive the consist 106 of revenue cars 108, 110, and 112 in the direction of travel ‘D’.

The present disclosure relates to a system 200 for monitoring operation of the locomotive 102. With continued reference to FIG. 1, the system 200 includes a plurality of cameras 202 that are strategically mounted onto the locomotive 102. Three cameras are shown in the illustrated embodiment of FIG. 1 and denoted with numerals 202a, 202b, and 202c respectively. However, it will be appreciated that in alternative embodiments, any number of cameras could be mounted to the locomotive 102 depending on specific requirements of an application. Therefore, it may be noted that a number of cameras disclosed herein is merely exemplary in nature and non-limiting of this disclosure.

Each of these cameras 202a, 202b, and 202c is configured to capture a video stream of an environment associated with the locomotive 102. In one embodiment as shown in FIG. 1, at least one camera such as camera 202a is mounted to the locomotive 102 for capturing a video stream pertaining to an oncoming railroad 104. In various embodiments disclosed herein, the camera 202a could also be configured to capture a video stream pertaining to an oncoming train (not shown).

Additionally, another camera such as camera 202b may be mounted to the locomotive 102 for capturing a video stream of an underside of the locomotive 102. Further, another camera such as camera 202c may be mounted to the locomotive 102 for capturing a video stream pertaining to an interior 120 of a cab 118 of the locomotive 102. It will be appreciated that in embodiments disclosed herein, any number of cameras can be mounted to the locomotive 102 for purposes of capturing a video stream pertaining to the environment of the locomotive 102 without deviating from the scope of the present disclosure.

The system 200 further includes a controller 204 that is remotely disposed from each of the cameras 202a, 202b, and 202c. The controller 204 is communicably coupled to each of the cameras 202a, 202b, and 202c over a wireless network such as, but not limited to, a Cellular network, Internet for e.g., Wi-Fi, or a Satellite communication network. A type of wireless network employed between the controller 204 and the cameras 202a, 202b, and 202c is merely exemplary in nature. A person skilled in the art can beneficially contemplate using various other types of wireless networks to dispose the controller 204 in wireless communication with each of the cameras 202a, 202b, and 202c present on the locomotive 102.

The controller 204 is configured to receive a video stream from each of the cameras 202a, 202b, and 202c. In the illustrated embodiment of FIG. 1, if each of the three cameras 202a, 202b, and 202c is operational, then the controller 204 may receive three video streams i.e., one video stream from each camera 202a, 202b, and 202c.

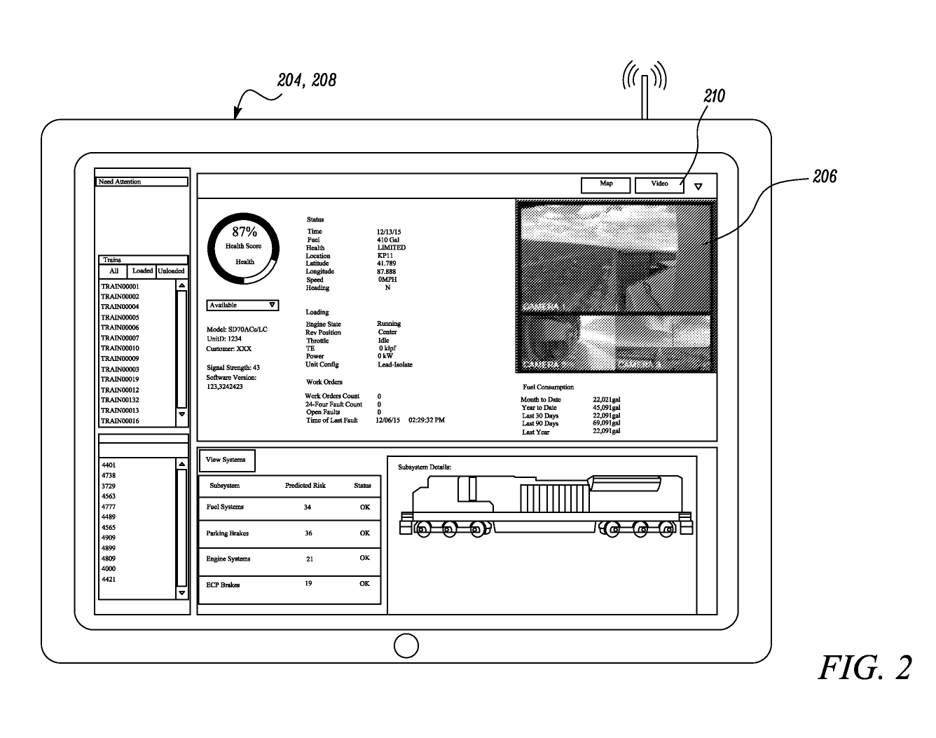

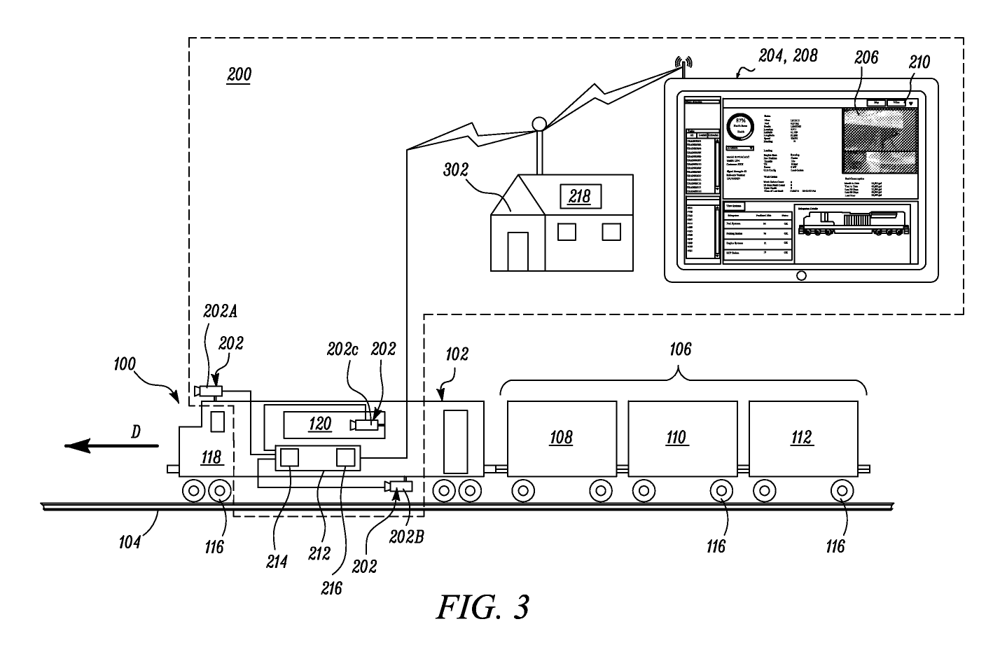

The system 200 further includes at least one graphical user interface 206 (hereinafter simply referred to as ‘GUI’ and referenced with identical numeral ‘206’). The GUI 206 is communicably coupled to the controller 204 and is configured to display the video streams received from each of the cameras 202a, 202b, and 202c upon demand the controller 204. In embodiments disclosed herein, the controller 204 and the GUI 206 are beneficially configured to integrally form part of a portable computing device 208 such as that exemplarily shown in FIG. 2. In various embodiments herein, the controller 204 is configured to trigger the GUI 206 to display the video streams in response to a user-initiated request. As shown in the exemplary portable computing device 208 of FIG. 3, the portable computing device 208 includes a user-selectable key ‘video’ denoted by numeral ‘210’. With actuation of the user-selectable key 210, an operator can selectively command the controller 204 into triggering a live feed of the video streams (or a playback of recorded video stream/s) on the GUI 206. Moreover, the controller 204 of the portable computing device 208 may be operable via other user-selectable keys for modulating various operating parameters of the locomotive 102 based on the environment associated with the locomotive 102, the environment being determined from the video streams transmitted by the cameras 202a, 202b, and 202c. For e.g., the controller 204 may be operable for increasing or decreasing an engine speed, for halting the locomotive 102, or for increasing an amount of braking force on the wheels 116 of the locomotive 102 and/or the revenue cars 108, 110, and 112 (refer to FIG. 1).

Referring again to FIG. 2, the controller 204 is in communication with multiple inputs and outputs to be described. The controller 204 may be form part of any device such as, but not limited to, the portable computing device 208 that can operably control the receipt and processing of video obtained from the various cameras 202a, 202b, and 202c while also generating commands and/or data for provision to the various outputs.

The controller 204 may be based on integrated circuitry, discrete components, or a combination of the two. In an embodiment, the controller 204 is implemented via a computerized device such as a PC, laptop computer, or integrated machine computer which may be configured to serve the functions of controller 204 as well as numerous other machine functions. In an alternative embodiment as shown in FIG. 2, the controller 204 is a dedicated module. In such a case, the controller 204 may be a processor-based device or collection of devices. In an alternative embodiment, the controller 204 could be implemented via an electronic control module (ECM).

Regardless of how it is implemented, the controller 204 operates, in an embodiment, by executing computer-executable instructions read from a non-transitory computer-readable medium such as a read only memory, a random access memory, a flash memory, a magnetic disc drive, an optical disc drive, and the like. In addition to these instructions, the data processed by the controller 204 may be read from memory in addition to being obtained from one or more of the various machine inputs. The memory may reside on the same integrated circuit device as the processor of the controller 204 or may, alternatively or additionally, be located separately from the controller 204 for e.g., at a remote operator center 302 such as that shown in FIG. 3.

While the controller 204 and its various inputs and outputs can be regarded as being representative of a spoke and hub architecture herein, it will be appreciated that any suitable bus type may be used. For example, in alternative embodiments of this disclosure, inputs and outputs may be serially multiplexed by time or frequency rather than being provided over separate connections. It will be appreciated that peripheral circuitry such as buffers, latches, switches and so on may be implemented within the controller 204 or separately as desired. Because those of skill in the art will appreciate the usage of such devices, they will not be further described herein.

In an embodiment as shown in FIG. 3, a schematic diagram of the remote operator center 302 in conjunction with the system 200 is shown. The remote operator center 302 is configured to facilitate unidirectional or bidirectional communications between the locomotive 102 and the system 200. The remote operator center 302 could optionally include facilities that allow the operator to view, via video, the operation of each camera 202a, 202b, and 202c, as well as to control one or more of the cameras 202a, 202b, and 202c onboard the locomotive 102. For example, when a camera 202a, 202b, or 202c is being remotely controlled by the operator, the communications from the operator center 302 to the camera 202a, 202b, or 202c in question may contain control information, and returning communications may contain status and video information. As such, the cameras 202 in the illustrated example include the first camera 202a, the second camera 202b, and the third camera 202c. When some of the cameras 202a, 202b, and/or 202c are not currently being controlled, but instead operating in another manner, for e.g., autonomously, then such cameras 202a, 202b, and/or 202c may provide status and video information to the operator center 302 without receiving control commands from the operator center 302.

In an embodiment, the communications between the operator center 302 and each of the cameras 202a, 202b, and 202c is wireless, and may be direct, as in the case of short range wireless communications technology; or may be indirect, as in the case of cellular or other long range communications technologies. In addition, all or some part of such communications may be encrypted or encoded for security purposes. For example, encryption of remote control commands from the controller 204 may prevent unauthorized third parties from controlling a camera 202a, 202b, or 202c in an unintended or adverse manner.

It will be appreciated that in an implementation of the described architecture, the operator center 302 can be suitably adapted for control and monitoring of the various cameras 202a, 202b, 202c, while the various cameras 202a, 202b, and 202c are configured to communicate with and may receive control data from the operator center 302.

In an embodiment as shown in FIG. 3, the system 200 may additionally include a transceiver 212 mounted on-board the locomotive 102. The transceiver 212 may be disposed in communication with each camera 202a, 202b, and 202c, the operator center 302, and the controller 204. The transceiver 212 may be adapted to receive the video streams from each of the cameras 202a, 202b, and 202c. The transceiver 212 may be of a type that can beneficially compress the video streams and render the video streams with a pre-defined amount of frames per second (fps) therein. The transceiver 212 may include associated system software and/or hardware for e.g., a compression engine 214 as shown in FIG. 3 that can accomplish compression functions on one or more of the video streams to the required frame rate. Thereafter, the transceiver 212 can transmit the compressed video streams to the controller 204.

In an embodiment of this disclosure, the video streams may be compressed at the compression engine 214 of the transceiver 212 to about four to eight frames per second (fps). For example, in one application or in case of a network having limited bandwidth, the transceiver 212 may be configured to compress each of the video streams to a frame rate of four fps. In another example, the transceiver 212 may be configured to output compressed video streams that have a frame rate of six fps. Therefore, notwithstanding anything contained in this document, it should be noted that the exact frame rate to which each video is compressed could, additionally or optionally, also depend on various other factors such as, but not limited to, a type of the wireless network used, bit rate that is supported by the wireless network, available bandwidth in the wireless network, and the like.

Moreover, the video streams could also be encrypted by the transceiver 212 prior to transmission by the transceiver 212 to the controller 204 and/or the remote operator center 302. Referring to FIG. 3, the transceiver 212 could beneficially include a video encoder 216 therein that can be linked to the first, second, and third cameras 202a, 202b, and 202c. The video encoder 216 can therefore encode or encrypt data from the video stream/s prior to transmission. A type or configuration of the video encoder 216 used is merely exemplary in nature and non-limiting of this disclosure. The video encoder 216 disclosed herein can be of any suitable type that is commonly known to persons skilled in the art.

In an alternate embodiment, rather than the video cameras 202a, 202b, 202c being linked to the video encoder 216, the video cameras 202a, 202b, and 202c can be configured to incorporate the video encoding functionality. In this alternative embodiment, the video encoder 216 can simply serve as a switch or multiplexer as would be known to persons skilled in the art.

Referring to FIG. 3, the system 200 may further include a recording module 218. The recording module 218 may be communicably linked to the transceiver 212 and the controller 204. In one embodiment as shown in FIG. 3, the recording module 218 could be located at the remote operator center 302. However, in alternative embodiments, the recording module 218 can optionally form part of (i.e., be integrated with) the transceiver 212 or the portable computing device 208. The recording module 218 is configured to receive the video streams from the transceiver 212, and record the received video streams therein at a first time for facilitating playback at a subsequent period of time. As the recording module 218 is in communication with the controller 204, the controller 204 can be operated for commanding the recording module 218 to render the recorded video streams at the GUI 206 during the subsequent period of time.

In various embodiments of the present disclosure, it is also contemplated that each camera 202a, 202b, and 202c may be beneficially configured to output a time stamp (shown in FIG. 2) corresponding to the captured video stream of the environment associated with the locomotive 102. In this manner, the recording module 218 can beneficially render the time stamps for the recorded video streams at the GUI 206 when video playback is requested at the GUI 206 by the controller 204.

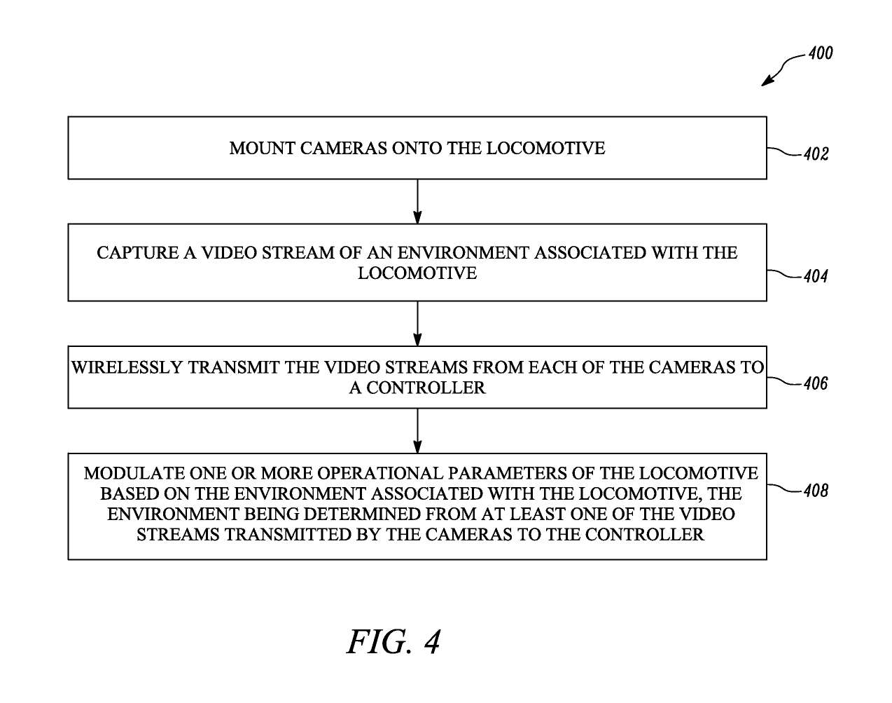

FIG. 4 is a flowchart illustrating a computer-implemented method 400 for monitoring operation of the locomotive 102, according to an embodiment of the present disclosure.

At step 402, the method 400 includes mounting multiple cameras 202a, 202b, and 202c onto the locomotive 102. At step 404, the method 400 further includes capturing, by at least one camera 202a, 202b, or 202c, a video stream of the environment that is associated with the locomotive 102. Although it is hereby contemplated to use at least one camera such as camera 202a for capturing a video stream of the oncoming railroad 104 and/or the oncoming train (not shown), at least one other camera such as camera 202b for capturing a video stream of the underside of the locomotive 102, and at least one other camera such as camera 202c for capturing a video stream of the interior 120 of the cab 118 of the locomotive 102, one skilled in the art can beneficially contemplate mounting fewer or more cameras, and at other strategic locations on the locomotive 102 depending on specific requirements of an application.

At step 406, the method 400 further includes wirelessly transmitting the video streams from the cameras 202a, 202b, and 202c to the controller 204. In an embodiment, the method 400 further includes compressing the video streams before transmission so that the video streams are rendered with a pre-defined amount of frames per second (pre-defined frame rate) therein. As disclosed earlier herein, the frame rate could be beneficially reduced to for e.g., four fps, six fps, or to any other frame rate depending on specific requirements of an application. Once compressed, the compressed video streams can then be transmitted wirelessly to the controller 204 with low use of bandwidth from the wireless network.

Additionally or optionally, the method 400 could further include encrypting the video streams (compressed or uncompressed video streams) prior to transmission by the transceiver 212 to the controller 204. This way, the video streams may be easily decoded at the controller 204 for actionable purposes.

At step 408, the method 400 further includes modulating one or more operational parameters of the locomotive 102 based on the environment associated with the locomotive 102, the environment being determined from at least one of the video streams transmitted by the cameras 202a, 202b, and 202c to the controller 204.

In another embodiment, the method 400 could also include recording the video streams at a first time for facilitating playback at a subsequent period of time. As disclosed in an embodiment herein, the system 200 may, optionally or additionally, include the recording module 218 for recording the video streams received from the cameras 202a, 202b, and 202c. Moreover, as each camera 202a, 202b, and 202c can be beneficially configured to provide a time stamp corresponding to the captured video stream, the method 400 could beneficially include rendering the playback of the video together with the time stamp at the GUI 206. This way, past conditions pertaining to the environment associated with the locomotive 102, and/or past operating conditions of the locomotive 102 may be tracked remotely by the operator and such tracking may assist the operator in taking preventive and/or corrective measures in the operation of the locomotive 102.

In an example, if the camera 202c has captured, by way of a video stream, that an intruder is in the cab 118 and that safety of the locomotive 102 has been compromised, then such video stream, if recorded at the recording module 218, can allow the operator to accomplish playback of the video stream together with the time stamp at the GUI 206 and note the same. Subsequently, the operator may issue appropriate commands to the controller 204 so that the controller 204 can in turn wirelessly instruct the locomotive 102 to execute specific functions for e.g., stall the engine or bring the locomotive 102 to a halt. As such, the controller 204 and the GUI 206 are configured to integrally form part of a single portable computing device 208 in which the controller 204 triggers the GUI 206 to display the video stream/s in response to a request initiated by the remotely located user or operator of the locomotive 102.

In methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims

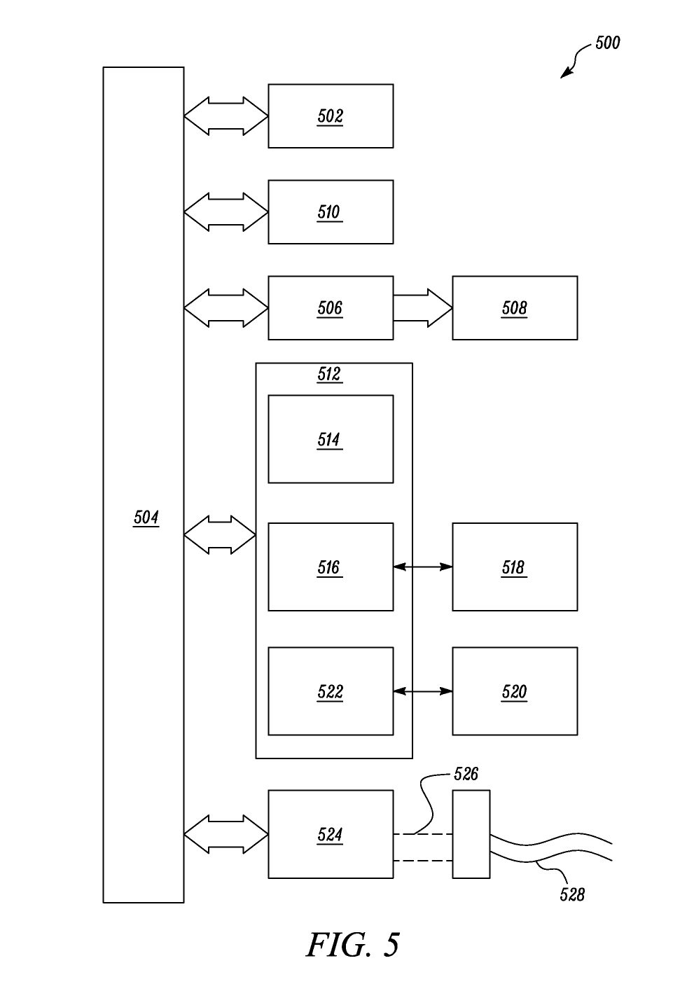

FIG. 5 is a block diagram of an exemplary computer system 500 that can be configured to execute instructions consistent with embodiments of the present disclosure. The present disclosure has been described herein in terms of functional block components, screen shots, schematic circuits (as shown in FIGS. 1-3), and various process steps (as shown in FIG. 4). It should be appreciated that such functional blocks may be realized by any number of hardware and/or software components configured to perform the specified functions. For example, a general purpose machine such as computer system 500, may employ various integrated circuit components, e.g., memory elements, processing elements, logic elements, look-up tables, and/or the like, which may carry out a variety of functions under the control of one or more microprocessors or other control devices. Similarly, the software elements for executing the functions consistent with the present disclosure may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that method 400 may be implemented by employing any number of conventional techniques for data transmission, signaling, data processing, network control, and/or the like. In an embodiment, method 400 may be implemented by the computer 500 using various architecture or platforms such as, but not limited to JavaScript, VBScript, .Net (dot-Net) platform or the like. However, it may be apparent to a person ordinarily skilled in the art that various other software frameworks may be utilized to build the architecture of the computer 500 without departing from the spirit and scope of the disclosure.

These software elements may be loaded onto the general purpose machine or computer 500, a special purpose computer, or any other programmable data processing apparatus, such that the instructions that execute on the computer 500, the special purpose computer, or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce instructions which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The present disclosure (i.e., system 200, method 400, any part(s) or function(s) thereof) may be implemented using hardware, software or a combination thereof, and may be implemented in one or more computer systems or other processing systems. However, the manipulations performed by the present disclosure were often referred to in terms, such as capturing, receiving, transmitting, modulating, or checking, which are commonly associated with mental operations performed by a human operator. No such capability of a human operator is necessary, or desirable in most cases, in any of the operations described herein, which form a part of the present disclosure. Rather, the operations are machine operations. Useful machines for performing the operations in the present disclosure may include general-purpose digital computers or similar devices.

In fact, in accordance with an embodiment of the present disclosure, the present disclosure is directed towards one or more computer systems capable of carrying out the functionality described herein. An example of the computer-based system includes the computer system 500, which is shown by way of a block diagram in FIG. 5.

Computer system 500 includes at least one processor, such as a Processor 502. Processor 502 may be connected to a communication infrastructure 504, for example, a communications bus, a crossover bar, a network, and the like. Various software embodiments are described in terms of this exemplary computer system 500. Upon perusal of the present description, it will become apparent to a person skilled in the relevant art(s) how to implement the present disclosure using other computer systems and/or architectures.

Computer system 500 includes a display interface 506 that forwards graphics, text, and other data from communication infrastructure 504 (or from a frame buffer) for display on a display unit 508.

Computer system 500 further includes a main memory 510, such as random access memory (RAM), and may also include a secondary memory 512. Secondary memory 512 may further include, for example, a hard disk drive 514 and/or a removable storage drive 516, representing a floppy disk drive, a magnetic tape drive, an optical disk drive, etc. Removable storage drive 516 reads from and/or writes to a removable storage unit 518 in a well-known manner. Removable storage unit 518 may represent a floppy disk, magnetic tape or an optical disk, and may be read by and written to by removable storage drive 516. As will be appreciated, removable storage unit 518 includes a computer usable storage medium having stored therein, computer software and/or data.

In accordance with various embodiments of the present disclosure, secondary memory 512 may include other similar devices for allowing computer programs or other instructions to be loaded into computer system 500. Such devices may include, for example, a removable storage unit 520, and an interface 522. Examples of such may include a program cartridge and cartridge interface (such as that found in video game devices), a removable memory chip (such as an erasable programmable read only memory (EPROM), or programmable read only memory (PROM)) and associated socket, and other removable storage units 520 and interfaces 522, which allow software and data to be transferred from removable storage unit 520 to computer system 500.

Computer system 500 may further include a communication interface 524. Communication interface 524 allows software and data to be transferred between computer system 500 and external devices. Examples of communication interface 524 include, but may not be limited to a modem, a network interface (such as an Ethernet card), a communications port, a Personal Computer Memory Card International Association (PCMCIA) slot and card, and the like. Software and data transferred via communication interface 524 may be in the form of a plurality of signals, hereinafter referred to as signals 526, which may be electronic, electromagnetic, optical or other signals capable of being received by communication interface 524. Signals 526 may be provided to communication interface 524 via a communication path (e.g., channel) 528. Communication path 528 carries signals 526 and can be implemented using wire or cable lines, fiber optic lines, telephone links, cellular links, radio frequency (RF) links, and/or other communication channels known to one skilled in the art.

In this document, the terms “computer program medium” and “computer usable medium” are used to generally refer to media such as removable storage drive 516, a hard disk installed in hard disk drive 514, signals 526, and the like. These computer program products provide software to computer system 500. The present disclosure is directed to such computer program products.

Computer programs (also referred to as computer control logic) may be stored in main memory 510 and/or secondary memory 512. Computer programs may also be received via the communication interface 504. Such computer programs, when executed, enable computer system 500 to perform the functions consistent with the present disclosure. In particular, the computer programs, when executed, enable Processor 502 to perform the features of the present disclosure. Accordingly, such computer programs represent controllers of computer system 500.

In accordance with an embodiment of the present disclosure, where the disclosure is implemented using a software, the software may be stored in a computer program product and loaded into computer system 500 using removable storage drive 516, hard disk drive 514 or communication interface 524. The control logic (software), when executed by Processor 502, causes Processor 502 to perform the functions of the present disclosure as described herein.

In another embodiment, the present disclosure is implemented primarily in hardware using, for example, hardware components such as application specific integrated circuits (ASIC) Implementation of the hardware state machine so as to perform the functions described herein will be apparent to persons skilled in the relevant art(s).

In yet another embodiment, the present disclosure is implemented using a combination of both the hardware and the software.

Various embodiments disclosed herein are to be taken in the illustrative and explanatory sense, and should in no way be construed as limiting of the present disclosure. All joinder references (e.g., attached, affixed, coupled, engaged, connected, and the like) are only used to aid the reader's understanding of the present disclosure, and may not create limitations, particularly as to the position, orientation, or use of the systems/devices and/or methods disclosed herein. Such joinder references are to be construed broadly. Moreover, such joinder references can infer that two elements or modules are not directly connected to each other.

Further, all numerical terms, such as, but not limited to, “first”, “second”, “third”, or any other ordinary and/or numerical terms, should also be taken only as identifiers, to assist the reader's understanding of the various cameras, embodiments, variations, components, and/or modifications of the present disclosure, and may not create any limitations, particularly as to the order, or preference, of any camera, embodiment, variation, component and/or modification relative to, or over, another camera, embodiment, variation, component and/or modification.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

Embodiments of the present disclosure have applicability for implementation and use in remotely monitoring operation of a locomotive. Accordingly, embodiments of the present disclosure can help reduce an overall effort and fatigue experienced by operators in operating the locomotives.

With use of embodiments disclosed herein, operators can conveniently monitor an operation and performance of locomotives given the varying nature of environments associated therewith. In some embodiments of this disclosure, when specific events occur, the controller 204 can be optionally configured to trigger the GUI 206 into displaying the appropriate video stream captured by the cameras 202a, 202b, and 202c. For example, in the case of specific events such as when an object or vehicle is being dragged by the locomotive 102, or when the oncoming railroad 104 is inundated with water, or if there has been a fire associated with an oncoming train, or if there has been a fire at the locomotive 102, or if there has been a shift in the position of the rails 104 due to activities such as mine-blasting, earthquakes and the like, the controller 204 can beneficially trigger the GUI 206 into displaying the appropriate video in order to help the operator take suitable course of action. The operators may operate the controller 204 with appropriate commands so that the controller 204 can in turn wirelessly instruct the locomotive 102 to execute specific functions for e.g., stall the engine, bring the consist 106 to a halt, or the like.

With implementation of the concepts disclosed herein, operators of locomotives can be adequately equipped to take informed decisions for various events associated with an environment of the locomotive. Moreover, as the cameras 202a, 202b, and 202c are located strategically on the locomotive 102, the video streams fed to the portable computing device 208 can allow the operator to, quickly and conveniently, note down events visually from the GUI 206 while being remotely located with respect to the locomotive 102.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for monitoring operation of a locomotive, the system comprising:
a plurality of cameras strategically mounted to the locomotive, each of the cameras configured to capture a video stream of an environment associated with the locomotive; and
a controller remotely disposed from and communicably coupled to the plurality of cameras over a wireless network, the controller configured to receive a plurality of video streams from the plurality of cameras; and
at least one graphical user interface (GUI) communicably coupled to the controller, the GUI configured to display the plurality of video streams received at the controller, wherein the controller is operable for modulating operating parameters of the locomotive based on the environment associated with the locomotive, as determined from the one or more video streams transmitted by the plurality of cameras.

2. The system of claim 1, wherein the controller and the GUI are configured to integrally form part of a portable computing device, and wherein the controller triggers the GUI to display the plurality of video streams in response to a user-initiated request.

3. The system of claim 1, wherein the wireless network includes at least one of: Cellular network, Internet, Satellite communication network.

4. The system of claim 1 further comprising a transceiver mounted on-board the locomotive and disposed in communication with the plurality of cameras and the controller, wherein the transceiver is configured to:
receive the plurality of video streams from the plurality of cameras;
compress the video streams so as to render the video streams with a pre-defined amount of frames per second therein; and
transmit the compressed video streams to the controller.

5. The system of claim 4, wherein the video streams are encrypted prior to transmission by the transceiver to the controller.

6. The system of claim 4, wherein the pre-defined amount of frames per second is about 4 to 8 frames per second.

7. The system of claim 4 further comprising a recording module communicably coupled to the transceiver and the controller, the recording module configured to:
receive the video streams from the transceiver, and
record the video streams therein at a first time for facilitating playback at a subsequent period of time.

8. The system of claim 1, wherein each of the cameras is configured to output a time stamp corresponding to the captured video stream of the environment associated with the locomotive.

9. The system of claim 1, wherein at least one camera is configured for capturing a video stream pertaining to at least one of: an oncoming railroad and an oncoming train.

10. The system of claim 1, wherein at least one camera is configured for capturing a video stream of an underside of the locomotive.

11. The system of claim 1, wherein at least one camera is configured for capturing a video stream pertaining to an interior of a cab of the locomotive.

12. A computer-implemented method for monitoring operation of a locomotive, the method comprising:
mounting a plurality of cameras onto the locomotive;
capturing, by at least one camera, a video stream of an environment associated with the locomotive;
transmitting wirelessly, by a transceiver, the video streams from the plurality of cameras to a controller; and
modulating, at the controller, one or more operational parameters of the locomotive based on the environment associated with the locomotive, as determined from the one or more video streams transmitted by the plurality of cameras to the controller.

13. The computer implemented method of claim 12 further comprising compressing the video streams so as to render the video streams with a pre-defined amount of frames per second therein.

14. The computer implemented method of claim 13 further comprising transmitting the compressed video streams to the controller.

15. The computer implemented method of claim 13 further comprising encrypting the video streams prior to transmission by the transceiver to the controller.

16. The computer-implemented method of claim 13, wherein the pre-defined amount of frames per second is about 4 to 8 frames per second.

17. The computer implemented method of claim 13 further comprising recording the video streams at a first time for facilitating playback at a subsequent period of time.

18. The computer-implemented method of claim 17 further comprising providing a time stamp, by the cameras, corresponding to the captured video stream of the environment associated with the locomotive.

19. The computer implemented method of claim 13, wherein the controller and the GUI are configured to integrally form part of a portable computing device, and wherein the controller triggers the GUI to display the plurality of video streams in response to a user-initiated request.

20. The computer implemented method of claim 13, wherein the plurality of cameras are configured to capture video streams pertaining to at least one of:
an oncoming railroad;
an oncoming train;
an underside of the locomotive; and
an interior of a cab of the locomotive.
